(19) United States
(12) Patent Application Publication
(10) Pub. No.: US 2026/0044215 A1
(43) Pub. Date: Feb. 12, 2026

(54) IMAGE DISPLAY METHOD, NON-TRANSITORY COMPUTER-READABLE STORAGE MEDIUM STORING PROGRAM, AND IMAGE DISPLAY SYSTEM

(71) Applicant: SEIKO EPSON CORPORATION, Tokyo (JP)

(72) Inventors: Kazuyuki IINUMA, Azumino-shi (JP); Eita YAMAKI, Matsumoto-shi (JP)

(73) Assignee: SEIKO EPSON CORPORATION, Tokyo (JP)

(21) Appl. No.: 19/295,006

(22) Filed: Aug. 8, 2025

(30) Foreign Application Priority Data
Aug. 9, 2024 (JP) 2024-134218

(51) Int. Cl. G06F 3/01

(52) U.S. Cl. CPC G06F 3/016; G06F 3/011

(57) ABSTRACT

An image display system includes a sensor that detects a motion of a user, displays that display an image in a video space, and a processor that determines, based on output of the sensor, whether a first motion of the user after a stimulus to the tactile sense of the user is presented satisfies a first condition. The processor displays a first image in a first region of the video space with the displays when it is determined that the first motion satisfies the first condition.

The present application is based on, and claims priority from JP Application Serial Number 2024-134218, filed Aug. 9, 2024, the disclosure of which is hereby incorporated by reference herein in its entirety.

### BACKGROUND

### 1. Technical Field

The present disclosure relates to an image display method, a non-transitory computer-readable storage medium storing a program, and an image display system.

### 2. Related Art

In order to give a sense of immersion and a sense of presence to a user in a system that displays a video, a technique of changing a video according to a motion of the user on a display screen is known. For example, JP-A-2019-219820 discloses a video display system that displays a two-dimensional video from a camera position on a display screen, the video display system moving the camera position and causing an image object to appear in the video according to the position of a user on the display screen.

JP-A-2019-219820 is an example of the related art.

However, in the technique according to JP-A-2019-219820, a chance for changing the video is movement of the user who views the video or movement of the camera. For this reason, unless the user consciously moves on the display screen, processing for causing the image object to appear in the video sometimes does not proceed. In other words, since the image object does not appear unless the user consciously moves on the display screen, there is a problem in that a sense of immersion is lost in this sense and a sense of presence decreases.

### SUMMARY

According to an aspect of the present disclosure, there is provided an image display method including: presenting a stimulus to a tactile sense of a user; determining, based on output of at least one sensor that detects a motion of the user, whether a first motion of the user after the stimulus is presented satisfies a first condition; and displaying a first image in a first region of a video space with at least one display device when it is determined that the first motion satisfies the first condition.

According to an aspect of the present disclosure, there is provided a non-transitory computer-readable storage medium storing a program, the program causing a computer to execute: determining, based on output of at least one sensor that detects a motion of a user, whether a first motion of the user after a stimulus to a tactile sense of the user is presented satisfies a first condition; and causing at least one display device to display a first image in a first region of a video space when it is determined that the first motion satisfies the first condition.

According to an aspect of the present disclosure, there is provided an image display system including: at least one sensor configured to detect a motion of a user; at least one display device configured to display an image in a video space; and an information processing device configured to execute: determining, based on output of the at least one sensor, whether a first motion of the user after a stimulus to a tactile sense of the user is presented satisfies a first condition; and causing the at least one display device to display a first image in a first region of the video space when it is determined that the first motion satisfies the first condition.

### BRIEF DESCRIPTION OF THE DRAWINGS

FIG. 1 is a configuration diagram of an image display system according to a first embodiment.

FIG. 2 is a functional block diagram illustrating an example of functions of a processing device according to the first embodiment.

FIG. 3 is a diagram illustrating a disposition example of elements in the image display system according to the first embodiment.

FIG. 4 is a diagram illustrating an example of a background video and an image object superimposed on the background video.

FIG. 5 is a diagram illustrating a state in which a tactile stimulation device has operated.

FIG. 6 is a diagram illustrating a state in which a user has changed the direction of the head of the user.

FIG. 7 is a diagram illustrating a state in which a display mode of the image object changes.

FIG. 8 is a diagram illustrating a state in which the user has approached the image object.

FIG. 9 is a diagram illustrating a state in which the display mode of the image object further changes.

FIG. 10 is a flowchart illustrating an example of a first processing operation of the processing device.

FIG. 11 is a flowchart illustrating an example of a second processing operation following the first processing operation of the processing device.

FIG. 12 is a configuration diagram of an image display system according to a second embodiment.

FIG. 13 is a functional block diagram illustrating an example of functions of a processing device according to the second embodiment.

FIG. 14 is a perspective view illustrating the exterior of MR glasses illustrated in FIG. 13.

FIG. 15 is a diagram illustrating a disposition example of elements in the image display system according to the second embodiment.

### DESCRIPTION OF EMBODIMENTS

Preferred embodiments according to the present disclosure are explained below with reference to the accompanying drawings. In the drawings, dimensions and scales of sections are sometimes different from actual dimensions and scale, and there are also portions schematically illustrated in order to facilitate understanding. The scope of the present disclosure is not limited to the embodiments described below as long as there is particularly no description to the effect that the present disclosure is limited in the following explanation.

### 1. First Embodiment

### 1.1. Overview of an Image Display System

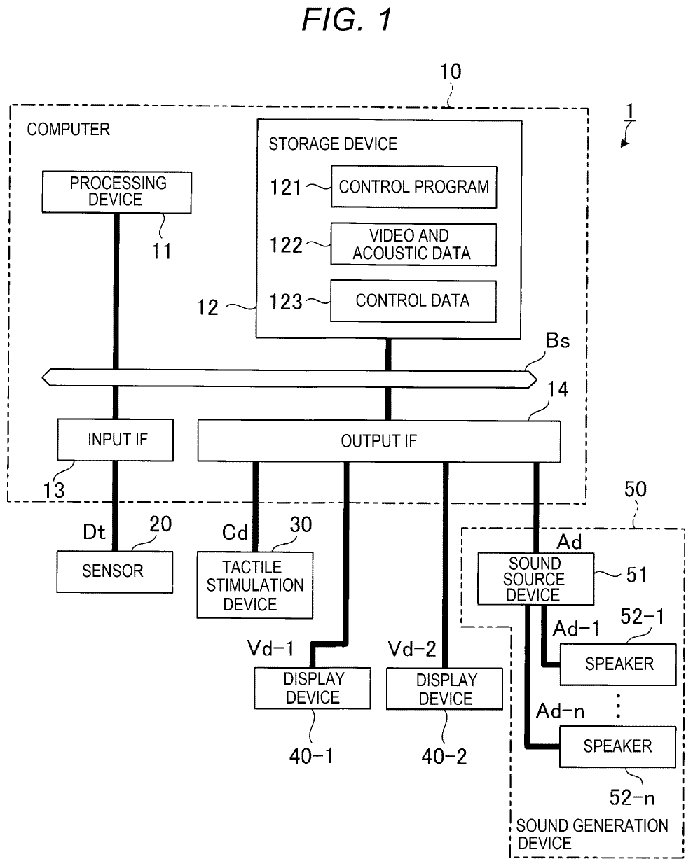

FIG. 1 is a configuration diagram of an image display system 1 according to a first embodiment. An overview of the image display system 1 according to the first embodiment is explained below with reference to FIG. 1. The image display system 1 includes a computer 10, a sensor 20, a tactile stimulation device 30, display devices 40-1 and 40-2, and a sound generation device 50.

The computer 10 controls the units in the image display system 1. The computer 10 includes a processing device 11, a storage device 12, an input interface (IF) 13, and an output IF 14. These devices are electrically coupled to one another via, for example, a bus Bs.

The processing device 11 controls an operation of the computer 10. The processing device 11 includes one or more CPUs. However, the processing device 11 may include an FPGA, a DSP, an ASIC, or the like instead of the CPUs or in addition to the CPUs. Here, CPU is an abbreviation of central processor, FPGA is an abbreviation of field-programmable gate array, DSP is an abbreviation of digital signal processor, and ASIC is an abbreviation of application specific integrated circuit.

The storage device 12 includes a volatile memory such as a RAM and a nonvolatile memory such as a ROM. Here, RAM is an abbreviation of random access memory. ROM is an abbreviation of read only memory. The storage device 12 stores a control program 121 for the processing device 11 to control the units, video and acoustic data 122 including video data and acoustic data, control data 123 including control parameters of the tactile stimulation device 30, and the like. The volatile memory of the storage device 12 is used by the processing device 11 as a work area of the processing device 11.

The storage device 12 may include a combination of a plurality of types of recording media. The storage device 12 may be a portable recording medium that is detachably attachable to the computer 10. Part or the entire storage device 12 may be provided in an external storage device, an external server, or the like. Some or all of various information stored in the storage device 12 may be stored in the storage device 12 in advance or may be acquired from the external storage device, the external server, or the like.

The input IF 13 and the output IF 14 are hardware serving as transmission and reception devices for communicating with other devices. The input IF 13 and the output IF 14 are also called, for example, network device, network controller, network card, and communication module. The input IF 13 and the output IF 14 may include a connector for wired connection and may include an interface circuit corresponding to the connector. The input IF 13 and the output IF 14 may include wireless communication interfaces. Examples of the connector for wired connection and the interface circuit include products conforming to wired LAN, IEEE1394, USB, and the like. Examples of the wireless communication interface include products conforming to wireless LAN and Bluetooth (registered trademark). Here, LAN is an abbreviation of local area network and USB is an abbreviation for universal serial bus.

The input IF 13 is a device for inputting imaging data Dt output from the sensor 20. The output IF 14 is a device for supplying control data Td to the tactile stimulation device 30, supplying a video signal Vd-1 to the display device 40-1, supplying a video signal Vd-2 to the display device 40-2, and supplying acoustic data to the sound generation device 50.

The sensor 20 is, for example, an imaging device and images an experiencing person who views and listens to videos and sound provided by the image display system 1 and outputs the imaging data Dt indicating a result of the imaging to the computer 10. The imaging device preferably has sensitivity enough to discriminate facial expression of the experiencing person in a dark place, and an infrared camera may be used as the imaging device.

A stereo camera may be used as the sensor 20. By using the stereo camera, the distance and the direction from the sensor 20 to the experiencing person are more accurately detected. A distance sensor may be used instead of the imaging device or together with the imaging device. Examples of the distance sensor include an ultrasonic sensor, a laser range sensor, and a millimeter wave radar.

An acceleration sensor may be used as the sensor 20. The acceleration sensor is attached to, for example, the head of the experiencing person. The acceleration sensor can detect a change in a behavior of the experiencing person, in particular, a change in movement of the head.

The sensor 20 may be a sensor that detects biometric information of the experiencing person. Examples of the sensor that detects biometric information of the experiencing person include a brain wave sensor, a pulse wave sensor, and a heart rate sensor. The brain wave sensor only has to be a sensor that is attached to the head of the experiencing person but has accuracy enough to discriminate whether the experiencing person is in a state of tension or a relaxed state. The pulse wave sensor is attached to, for example, the wrist of the experiencing person. A sensor provided in a smart watch carried by the experiencing person may be used as the pulse wave sensor. The brain wave sensor is also called heart rate sensor.

Note that, in order to simplify explanation, in the present embodiment, the sensor 20 is one imaging device. However, two or more sensors 20 may be used. As the sensor 20, any of a distance sensor, an acceleration sensor, and a biological sensor may be used instead of the imaging device or together with the imaging device or these sensors may be used in combination. When these sensors are used in combination, outputs of the sensors may be weighted or may be prioritized.

The experiencing person refers to a person who views and listens to videos and sound provided by the image display system 1. In the following explanation, the experiencing person is referred to as user for convenience.

The tactile stimulation device 30 is a device that presents a stimulus to the tactile sense of the user. The presenting a stimulus to the tactile sense of the user includes stimulating the tactile sense of the user. The presenting a stimulus to the tactile sense of the user includes transmitting the tactile sense to the user. The tactile stimulation device 30 includes at least one of a blower, a vibrator, and a driver.

The blower includes at least one of a blower fan and a vortex ring generator.

The blower fan sends wind toward the user to cause awareness to occur to the user. When a windless state changes to a state in which the wind blows against the user, the tactile sense of the user is stimulated and awareness can occur to the user. The state in which the wind blows against the user may be changed to the windless state in an audiovisual room 70 by stopping the blowing by the blower fan. In short, the movement of the air in the audiovisual room 70 only has to be changed. When the state in which the wind blows against the user is changed to the windless state by stopping the blowing, since the stimulus to the tactile sense disappears, awareness can occur to the user.

The blower fan may stimulate the tactile sense of the user by swinging a thread hung from the ceiling of the audiovisual room 70. The blower fan is preferably configured to freely change the strength of the wind and a blowing direction of the wind.

The vortex ring generator generates a vortex ring. The vortex ring generator is a so-called “air gun”. The vortex ring generated by the vortex ring generator is sent into the air. Since the vortex ring can move a relatively long distance without being dispersed, it is possible to accurately aim at the user. When the vortex ring hits the hand, the face, or the like of the user, the tactile sense of the user is stimulated and awareness can occur to the user.

The vortex ring generator is preferably configured to be able to freely change a direction in which the vortex ring is sent. The vortex ring generator may send a warm vortex ring by using warmed air. The vortex ring generator may send a vortex ring with a scent by using an aromatic, aromatic oil, or the like. The vortex ring generator may give a visual effect to the user by sending a smoke-like vortex ring with a smoke machine.

The vibrator is disposed, for example, below a specific position on the floor surface of the audiovisual room 70. As the vibrator, a vibration motor, a vibrator, or the like is used. When the user stands at the specific position, the tactile sense of the user is stimulated by vibrating the floor surface with the vibrator, and awareness can occur to the user. For a user who uses a wheelchair, the vibrator may be disposed in the wheelchair such that the seat surface of the wheelchair is vibrated.

The driver is disposed, for example, below a specific position on the floor surface of the audiovisual room 70. As the driver, a device obtained by combining a motor and a cam is used. The driver displaces the floor surface by slightly moving a part of the floor surface up and down. When the user is standing at the specific position, by displacing a part of the floor surface with the driver, the tactile sense of the user is stimulated and awareness can occur to the user.

The driver may be disposed on a wall surface of the audiovisual room 70. The driver causes a part of the wall surface to slightly protrude. When the user is standing at the specific position, by causing a part of the wall surface to protrude with the driver, the part of the wall surface is brought into contact with the user. Accordingly, the tactile sense of the user is stimulated and awareness can occur to the user.

As explained above, the presenting a stimulus to the tactile sense is, for example, moving the air in the video space with the blower. For example, when wind starts blowing, the user is considered to take an action such as turning the face in a direction in which the wind blows, that is, the windward. Therefore, the moving the air with the blower is equivalent to making the user aware.

The presenting a stimulus to the tactile sense is, for example, bringing a thread in the video space into contact with the user with the blower. For example, when a thread hung from the ceiling is swung by wind to thereby touch the head of the user, the user is considered to take an action such as looking around. As another example, cloth, feather, or paper may be used. Therefore, bringing a first object into contact with the user with the blower is equivalent to making the user aware.

The presenting a stimulus to the tactile sense is, for example, vibrating a part of the floor surface touched by the user with the vibrator. For example, when the user perceives the vibration of the floor surface, the user is considered to take an action such as looking at the feet. As another example, a structure configuring the video space such as a wall or a screen or an object installed in the video space such as a plate or a ball may be used. Therefore, vibrating a second object touched by the user with the vibrator is equivalent to making the user aware.

The presenting a stimulus to the tactile sense is, for example, bringing a part of the wall surface in the video space into contact with the user with the driver. For example, when a part of the wall surface touches the user, the user is considered to take an action such as gazing at a contact part. As another example, a screen, cloth, thread, feather, or the like may be used. Therefore, bringing a third object into contact with the user with the driver is equivalent to making the user aware.

The display devices 40-1 and 40-2 are specifically projectors. The display device 40-1 projects a video based on the video signal Vd-1 supplied from the computer 10. Like the display device 40-1, the display device 40-2 also projects a video based on the video signal Vd-2 supplied from the computer 10. Although the two display devices 40-1 and 40-2 are illustrated in FIG. 1 for convenience, the number of display devices may be one or may be three or more. The display devices 40-1 and 40-2 are not limited to the projectors and may be direct view-type panel display device. Each of the display devices 40-1 and 40-2 has a display unit configured to display images. The display unit comprises an example of a display. The configuration of the display unit is not particularly limited, provided that it has the function of displaying images.

The sound generation device 50 includes a sound source device 51 and speakers 52-1 and 52-2. The sound source device 51 applies a predetermined effect to acoustic data Ad supplied via the output IF 14 and converts the acoustic data Ad into n-channel analog acoustic signals Ad-1 to Ad-n. The sound source device 51 amplifies the acoustic signals Ad-1 to Ad-n and supplies the amplified acoustic signals Ad-1 to Ad-n respectively to speakers 52-1 to 52-n corresponding to the amplified acoustic signals Ad-1 to Ad-n in a one-to-one relation.

Examples of the effect that the sound source device 51 applies to the acoustic data include a stereophonic acoustic effect of giving a three-dimensional sound spread to background sound based on BGM data in the acoustic data and an effect of fixing or moving a sound image position of specific sound based on specific sound data. The speakers 52-1 to 52-n are sound emitting devices that convert the acoustic signals Ad-1 to Ad-n into sound that is physical vibration and output the sound into the air. FIG. 1 illustrates n speakers 52-1 to 52-n provided for each channel. If the sound image position is not changed and the stereophonic acoustic effect is not imparted, the number of speakers may be one.

### 1.2. Functions of the Processing Device

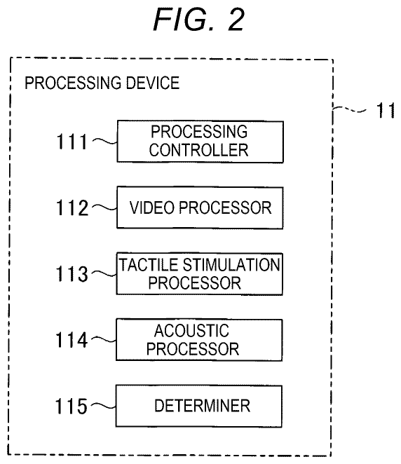

FIG. 2 is a functional block diagram illustrating an example of functions of the processing device 11 according to the first embodiment. FIG. 2 illustrates a functional configuration constructed by the processing device 11 of the computer 10 executing the control program 121 stored in the storage device 12. As illustrated in FIG. 2, the processing device 11 has functions serving as a processing controller 111, a video processor 112, a tactile stimulation processor 113, an acoustic processor 114, and a determiner 115. It is to be noted that the processing device 11 may simply be referred to as a processor.

The processing controller 111 starts reading the video and acoustic data 122 from the storage device 12 according to predetermined operation or the like and controls the units, that is, the video processor 112, the tactile stimulation processor 113, the acoustic processor 114, and the determiner 115.

The video processor 112 generates, according to the control by the processing controller 111, the video signals Vd-1 and Vd-2 based on video data in the video and acoustic data 122 read by the processing controller 111. The video signal Vd-1 generated in the video processor 112 is supplied to the display device 40-1 via the output IF 14. The video signal Vd-2 generated in the video processor 112 is supplied to the display device 40-2 via the output IF 14.

The tactile stimulation processor 113 generates, according to the control by the processing controller 111, a control signal Cd based on the control data 123 read by the processing controller 111. The control signal Cd generated in the tactile stimulation processor 113 is supplied to the tactile stimulation device 30 via the output IF 14.

The acoustic processor 114 outputs the acoustic data Ad in the video and acoustic data 122 read by the processing controller 111. The acoustic data Ad output from the acoustic processor 114 is supplied to the sound generation device 50 via the output IF 14.

The determiner 115 analyzes the imaging data Dt by the sensor 20 according to an instruction by the processing controller 111 and determines whether a behavior of the user has changed, in other words, whether a first motion of the user has satisfied a first condition. Note that the behavior of the user is specifically a direction, a facial expression, a direction of a line-of-sight, a standing position, or the like of at least one of the face and the body of the user. Temporal change speed of these may be considered for the change in the behavior of the user. Specifically, if the change speed of the behavior is less than a threshold, it may be determined that there is no change in the behavior.

The first motion is a motion, a behavior, or an action of the user. Specifically, the first motion is a motion of the user looking around, a motion of the user moving in the audiovisual room 70, a motion of the user stopping in a specific region, or the like. The user who is made aware by the stimulus of the tactile sense is considered to, besides performing a motion of looking around, move in a direction in which the stimulus of the tactile sense is received. The user who is made aware by the stimulus of the tactile sense is considered to stop on the spot.

The first condition includes an action pattern that can be taken by the user who is made aware by the stimulus of the tactile sense. More specifically, it is preferable that the action pattern is an action pattern having a high possibility of finding a first image displayed in a first region. For example, the first condition includes that the user is directing the face in the direction of the first region and that the user is visually recognizing an image displayed in the first region. The first region is a region where the first image is displayed. For example, since the user who is made aware by the stimulus of the tactile sense is considered to look around as an action due to the awareness, the user sometimes faces the direction of the first region. If the user is facing the direction of the first region, the user can easily find the first image to be displayed.

In the present embodiment, the display devices 40-1 and 40-2 display a video in which an image object is superimposed on a background video. The video data includes background video data indicating the background video and image object data indicating the image object. The background video data is video data indicating a background video of a forest, the sea, the sky, the space, or the like and, in the present embodiment, a video of a forest including a plurality of trees is used as the background video. The image object data is data indicating an image object such as an animal, a bird, a fish, a person, or a building superimposed on the background video. The image object includes an actual image, an image of a virtual object, and the like but does not include a background. In the present embodiment, data indicating a house and a person is used as the image object data.

The acoustic data includes the BGM data and sound effect data. The BGM data is data indicating music or environmental sound played in order to create an atmosphere when a video is displayed. The sound effect data is data indicating, to the user who is viewing the video, a sound effect to be played in response to a change in movement of the image object. The sound effect includes, for example, sound of a person walking, sound of opening and closing a door, and sound of leaves of trees swinging in wind. The sound effect may be natural sound recorded in advance or artificial sound synthesized by an electronic musical instrument or the like.

When an operator or an external device instructs to start display, the processing controller 111 starts reading the video and acoustic data 122. The processing controller 111 supplies the video data in the read video and acoustic data 122 to the video processor 112 and supplies the acoustic data to the acoustic processor 114.

The video processor 112 generates, as the video signals Vd-1 and Vd-2, a video in which the image object based on the image object data is superimposed on the background video based on the background video data in the video data.

### 1.3. Disposition Example of the Image Display System 1

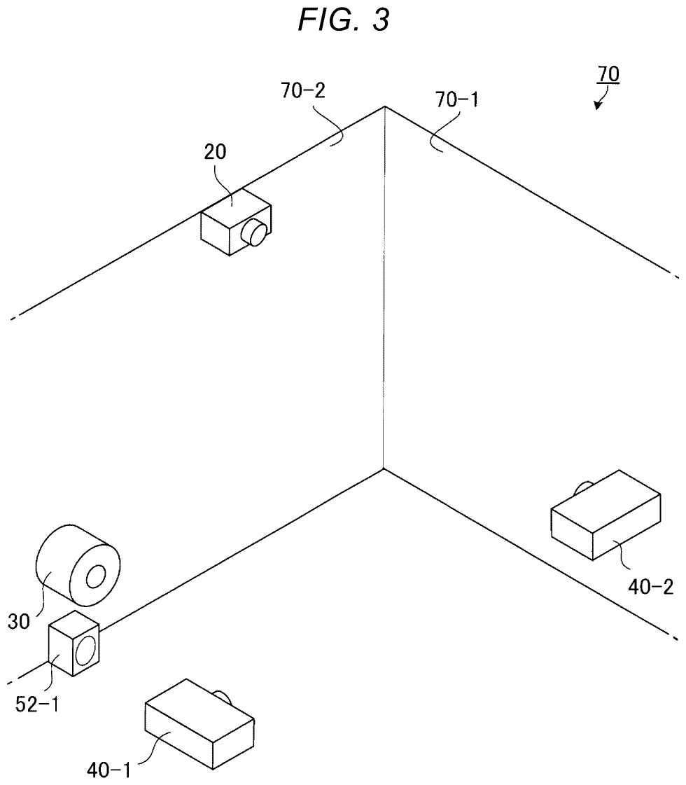

FIG. 3 is a diagram illustrating a disposition example of the elements in the image display system 1 according to the first embodiment. Although the elements in the image display system 1 are provided in the audiovisual room 70, in FIG. 3, parts of the ceiling and the wall surface in the audiovisual room 70 are omitted and only the speaker 52-1 among the speakers 52-1 to 52-n is illustrated in order to clearly explain the disposition example.

The sensor 20 is attached to, for example, a wall surface 70-2. The tactile stimulation device 30 is attached to, for example, the wall surface 70-2. The display device 40-1 projects a video onto a wall surface 70-1 in the audiovisual room 70. The display device 40-2 projects a video onto the wall surface 70-2 in the audiovisual room 70. The speaker 52-1 is attached to, for example, the wall surface 70-2. In this example, the videos are projected onto the wall surfaces 70-1 and 70-2. However, a projection surface for a video may be the entire wall surface of the audiovisual room 70 or may include at least one of the ceiling surface and the floor surface.

### 1.4. Specific Operation in the Image Display System 1

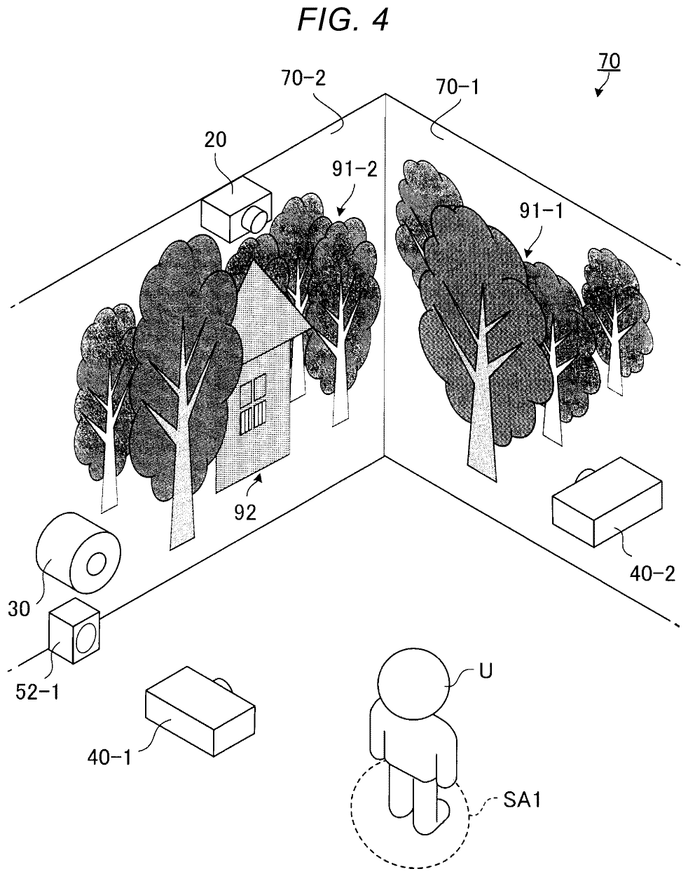

Subsequently, a specific operation in the image display system 1 is explained with reference to FIGS. 4 to 9. FIG. 4 is a diagram illustrating an example of a background video and an image object superimposed on the background video. As illustrated in FIG. 4, videos of a forest are continuously reproduced as background videos 91-1 and 91-2. Specifically, the display device 40-1 projects the background video 91-1 onto the wall surface 70-1 and the display device 40-2 projects the background video 91-2 onto the wall surface 70-2. In this example, the background videos 91-1 and 91-2 are videos of a dark forest. A user U faces the wall surface 70-1 and stops in a first specific region SA1. An image object 92 is a house. At this stage, since the image object 92 disappears in the dark forest, the image object 92 is not visually recognized by the user U.

The sensor 20 detects the presence of the user U and a motion of the user U.

When the determiner 115 determines that the user U is present in the first specific region SA1, the processing controller 111 causes the tactile stimulation processor 113 to cause the tactile stimulation device 30 to operate. In this example, the tactile stimulation device 30 is a vortex ring generator.

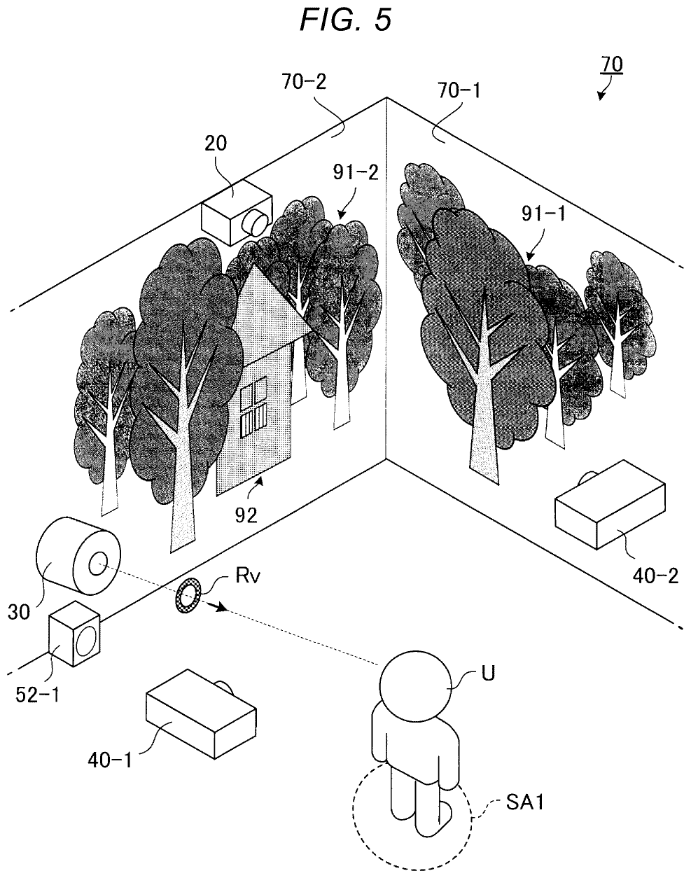

FIG. 5 is a diagram illustrating a state in which the tactile stimulation device 30 operates. As illustrated in FIG. 5, the tactile stimulation device 30 discharges a vortex ring Rv toward the head of the user U. Here, the air in the tactile stimulation device 30 is warmed by a heater and the temperature of the discharged vortex ring Rv is higher than the ambient temperature. The discharged warm vortex ring Rv advances toward the user U. Since the user U is facing the wall surface 70-1, the vortex ring Rv hits the left side of the head of the user U.

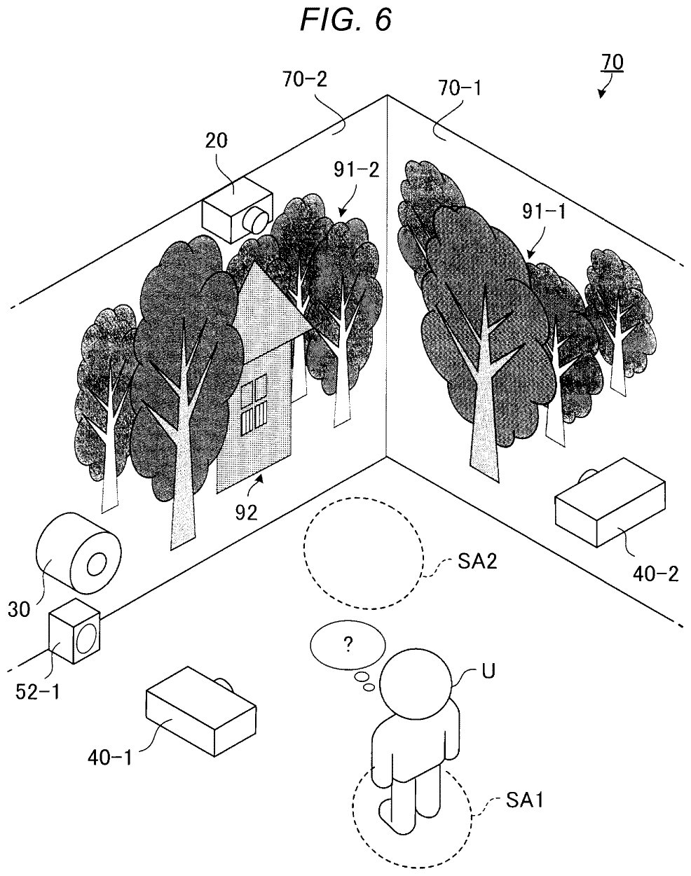

FIG. 6 is a diagram illustrating a state in which the user U has changed the direction of the head. When the vortex ring Rv hits the left side of the head of the user U and the user U feels discomfort, the user U is considered to perform a motion of looking around, a motion of facing a direction in which the user U has felt discomfort, or the like. In this example, since the vortex ring Rv hits the left side of the head of the user U, as illustrated in FIG. 6, the user U faces the left side as the user faces, that is, the direction of the wall surface 70-2. At this stage, the brightness of the image object 92 may be increased to make the user U easily aware of the presence of the image object 92.

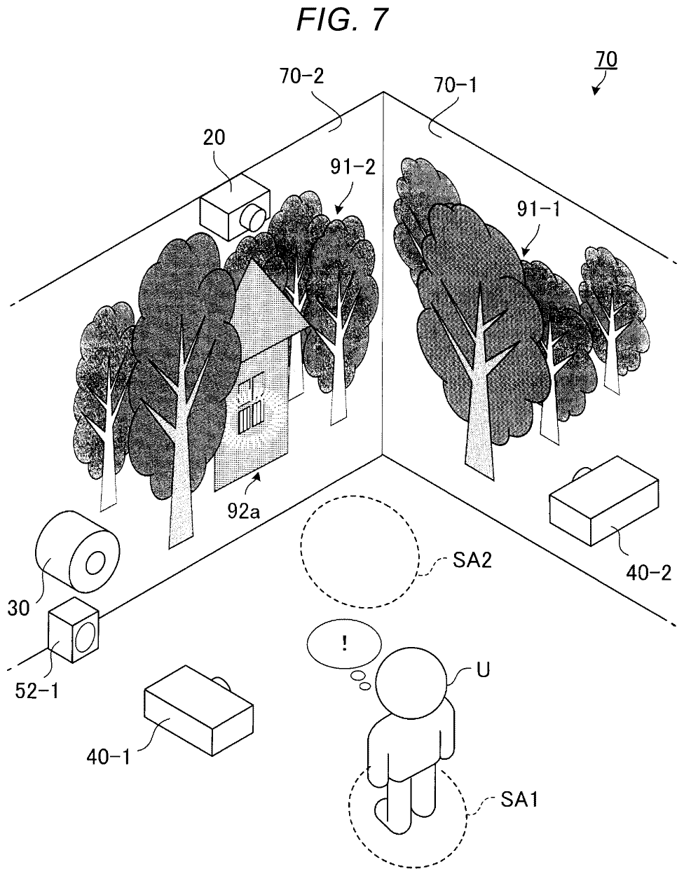

FIG. 7 is a diagram illustrating a state in which a display mode of the image object 92 changes. As illustrated in FIG. 7, a window is present in the image object 92 in the background video 91-2 and light leaking from the window starts slightly shining. A change from the image object 92 indicating a house where the light is not turned on to an image object 92a indicating the house where the light leaks from the window occurs at the opportunity when the user U faces the direction of the wall surface 70-2. In other words, an image object changes from the image object 92 of the house where the light is not turned on to the image object 92a of the house where the light leaks from the window.

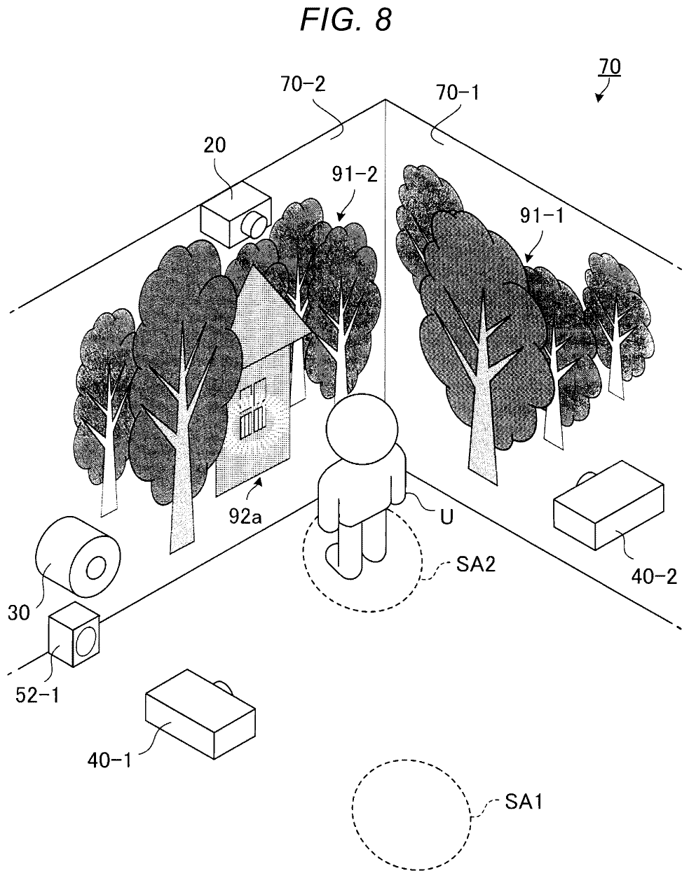

FIG. 8 is a diagram illustrating a state in which the user U has approached the image object 92. As illustrated in FIG. 8, when the user U is aware of slightly shining light, the user U approaches the image object 92 to check what the light really is. That is, the user U moves from the first specific region SA1 to a second specific region SA2.

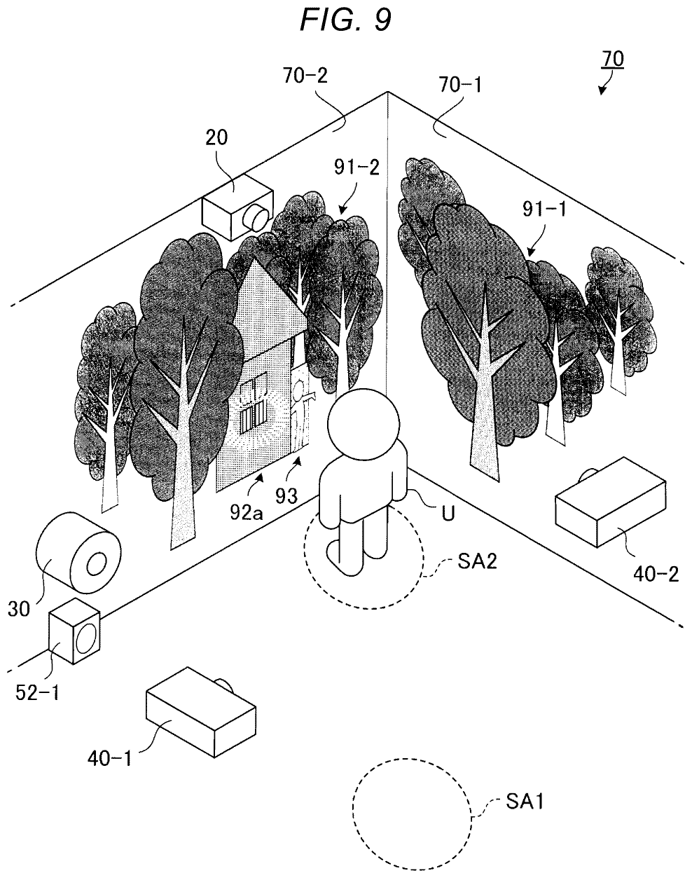

FIG. 9 is a diagram illustrating a state in which the display mode of the image object 92 further changes. As illustrated in FIG. 9, when the user U approaches the image object 92, the user U recognizes that the slightly shining light really is the light leaking from the window. When the user U stops in the second specific region SA2, a door 93 of the house opens and a person appears from the house. The determiner 115 is capable of detecting, by analyzing the imaging data Dt, which is output of the sensor 20, that the user U stops in the second specific region SA2.

As explained above, the user U is capable of experiencing, through awareness, feeling that the user U himself or herself has found the image object. Note that the display mode in this example, that is, the mode in which a house is built in a dark forest and light leaking from a window of the house starts to shine is only an example, and the present disclosure is not limited to this mode.

Timing when the tactile stimulation device 30 discharges the vortex ring Rv may be when the user U does not stop in the first specific region SA1. For example, the timing may be when the user U is approaching the tactile stimulation device 30 or when the distance of the user U from the tactile stimulation device 30 is within a reachable distance of the vortex ring Rv.

### 1.5. Specific Operation in the Image Display System 1

Subsequently, an operation of the image display system 1, more specifically, operations of the units by the processing device 11 in the computer 10 are explained.

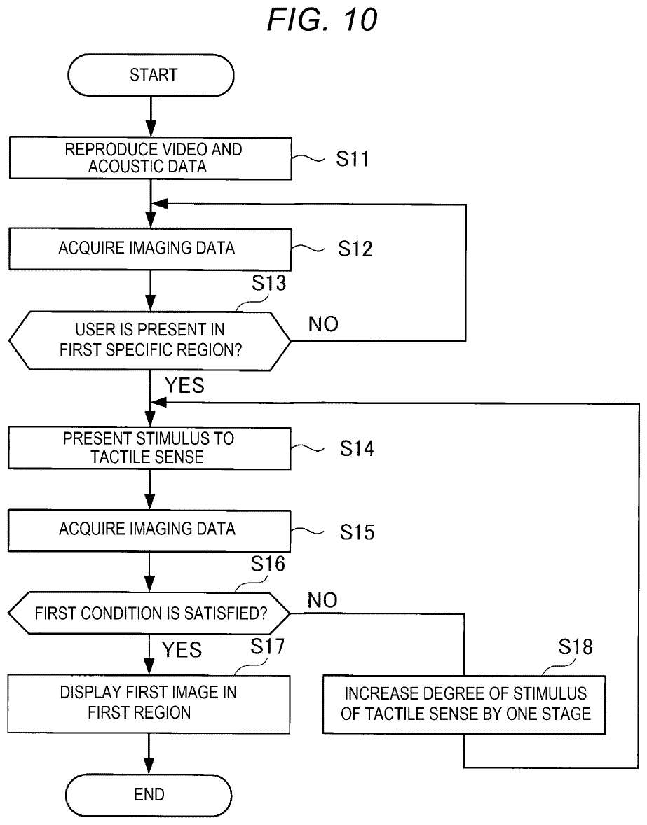

FIG. 10 is a flowchart illustrating an example of a first processing operation of the processing device 11. The first processing operation of the processing device 11 is explained below with reference to FIG. 10. A routine illustrated in FIG. 10 is started, for example, when a display start is instructed.

When the display start is instructed, in step S11, the processing device 11 functions as the processing controller 111 to thereby reproduce the video and acoustic data 122.

The processing device 11 transfers the video data in the read video and acoustic data 122 to the video processor 112 and transfers the acoustic data Ad to the acoustic processor 114. The video processor 112 generates the video signals Vd-1 and Vd-2 based on the transferred video data and supplies the video signals Vd-1 and Vd-2 respectively to the display devices 40-1 and 40-2. The acoustic processor 114 supplies the transferred acoustic data Ad to the sound generation device 50.

The display device 40-1 projects a video based on the video signal Vd-1 onto the wall surface 70-1 and the display device 40-2 projects a video based on the video signal Vd-2 onto the wall surface 70-2. The speakers 52-1 to 52-n sequentially generate sound based on the acoustic signals Ad-1 to Ad-n.

In step S12, the processing device 11 functions as the processing controller 111 to thereby acquire the imaging data Dt from the sensor 20.

In step S13, the processing device 11 functions as the determiner 115 to analyze the imaging data Dt by the sensor 20 and determine, based on a result of the analysis, whether the user U is present in the first specific region SA1.

When determining that the user U is present in the first specific region SA1, that is, when a determination result in step S13 is YES, in step S14, the processing device 11 functions as the tactile stimulation processor 113 to thereby present a stimulus to the tactile sense of the user U with the tactile stimulation device 30. In this example, the processing device 11 causes the tactile stimulation device 30 to discharge the warm vortex ring Rv toward the user U.

On the other hand, when determining that the user U is absent in the first specific region SA1, that is, when the determination result in step S13 is NO, in step S12, the processing device 11 functions as the processing controller 111 to thereby acquire the imaging data Dt from the sensor 20. That is, in this case, the processing device 11 executes the processing in step S12 and subsequent steps again.

In step S15, the processing device 11 functions as the processing controller 111 to thereby acquire the imaging data Dt from the sensor 20.

In step S16, the processing device 11 functions as the determiner 115 to thereby analyze the imaging data Dt acquired from the sensor 20 and determine, based on a result of the analysis, whether the first motion of the user U satisfies the first condition.

When determining that the first motion of the user U satisfies the first condition, that is, when a determination result in step S16 is YES, in step S17, the processing device 11 displays the first image in the first region and temporarily ends this routine.

On the other hand, when determining that the first motion of the user U does not satisfy the first condition, that is, when the determination result in step S16 is NO, in step S18, the processing device 11 functions as the tactile stimulation processor 113 to thereby increase a degree of the stimulus of the tactile sense by one stage. This is because the user U is likely to have not be aware of the stimulus of the tactile sense. Specifically, the processing device 11 changes setting of condition parameters for generating the vortex ring Rv with the tactile stimulation device 30 such that the degree of the stimulus of the tactile sense further increases. That is, the processing device 11 presents the stimulus with intensity of a first degree and, when it is determined that the first motion does not satisfy the first condition, presents the stimulus with intensity of a second degree higher than the first degree.

In order to further increase the degree of the stimulus, for example, the pressure applied to the air in the tactile stimulation device 30 when discharging the vortex ring Rv is increased. Accordingly, the size of the vortex ring Rv to be discharged can be further increased. A condition of heating by the heater may be changed to further raise the temperature of the air in the tactile stimulation device 30. A plurality of vortex rings Rv may be continuously generated. Further, a scent may be given to the vortex ring Rv using a fragrance, aromatic oil, or the like.

After executing the processing in step S18, in step S14, the processing device 11 functions as the tactile stimulation processor 113 to thereby present a stimulus to the tactile sense of the user U with the tactile stimulation device 30. That is, in this case, the processing device 11 executes the processing in step S14 and subsequent steps again. Step S14 before going through step S18 is an example of presenting a stimulus at the first degree. Step S14 following step S18 is an example of presenting a stimulus at the second degree.

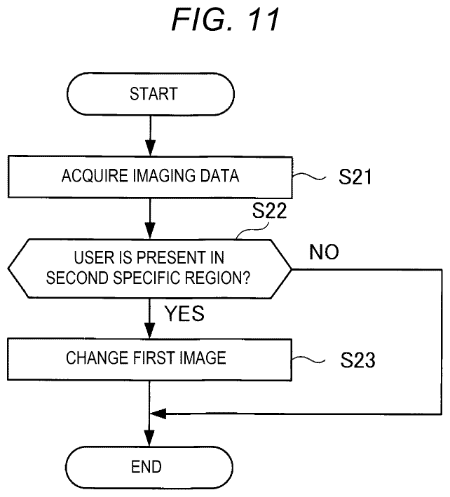

FIG. 11 is a flowchart illustrating an example of a second processing operation following the first processing operation of the processing device 11. The second processing operation of the processing device 11 is explained below with reference to FIG. 11. A routine illustrated in FIG. 11 is started subsequently after the end of the first processing operation.

When this routine is started following the first processing operation, in step S21, the processing device 11 functions as the processing controller 111 to thereby acquire the imaging data Dt from the sensor 20.

In step S22, the processing device 11 functions as the determiner 115 to thereby analyze the imaging data Dt and determine, based on a result of the analysis, whether the user U is present in the second specific region SA2.

When determining that the user U is present in the second specific region SA2, that is, when a determination result in step S22 is YES, in step S23, the processing device 11 functions as the video processor 112 to thereby change the first image and temporarily end this routine. Specifically, the processing device 11 changes, in the image object 92a, which is the first image, a state in which a door is not open to a state in which the door is open.

On the other hand, when determining that the user U is absent in the second specific region SA2, that is, when the determination result in step S22 is NO, the processing device 11 temporarily ends this routine. That is, in this case, the first image does not change.

### 1.6. Effects Achieved by the First Embodiment

As explained above, an image display method according to the first embodiment includes presenting a stimulus to the tactile sense of the user U, determining, based on the output of the sensor 20 that detects the motion of the user U, whether the first motion of the user U after the stimulus is presented satisfies the first condition, and displaying the first image on the wall surface 70-2 with the display device 40-2 when it is determined that the first motion satisfies the first condition.

With the image display method explained above, the first image is displayed when it is determined that the first motion of the user U after the stimulus is presented satisfies the first condition, and the first image is displayed on the wall surface 70-2 at the opportunity of a change in the behavior of the user U. For this reason, since the user U is caused to feel as if the first image is displayed at the opportunity of awareness of the user U himself or herself and a change in the behavior of the user U, it is possible to give a deep sense of immersion to the user U viewing a video and increase the sense of presence.

The video changing at the opportunity of the change in the behavior of the user U means, in other words, that the user U can be immersed in the change in the video without causing the user U to feel artifice of a video creator. Therefore, since the user U does not feel the artifice of the video creator, the user U has a feeling of finding the change in the video by himself or herself, and it is possible to expect development of a new interaction between the change in the video and the user U.

In the present embodiment, since the video changes at the opportunity of the change in the behavior of the user U, the user U concentrates on the video. For this reason, application to indirect treatment or calm down can be expected for a person with a rather frequent developmental disorder, a patient with a mental disorder whose thinking diverges, and the like.

In the first embodiment, the audiovisual room 70 is an example of a “video space”, the wall surface 70-2 is an example of a “first region”, and the image object 92 is an example of a “first image” and a “second image”. The image object 92a is an example of a “first image” and a “third image”. The display device 40-1 may be caused to display the first image.

The first condition is at least one of the user U directing the face of the user U in the direction of the wall surface 70-2 and the user U visually recognizing an image displayed in the first region.

Since it is conceivable that the user U who is made aware by the stimulus of the tactile sense looks around as an action due to the awareness, the user U sometimes faces the direction of the first region. According to this aspect, since the first image is displayed in the first region at the opportunity when the user U directs the face in the direction of the first region where the first image is to be displayed, the user U can easily find the displayed first image.

The presenting a stimulus includes at least one of moving the air in the audiovisual room 70 with the blower, bringing the first object in the audiovisual room 70 into contact with the user U with the blower, vibrating the second object touched by the user U with the vibrator, and bringing the third object in the audiovisual room 70 into contact with the user U with the driver.

According to this aspect, since the first image is displayed at the opportunity of the awareness of the user U, the user U can easily find the displayed first image. The thread hung from the ceiling is an example of a “first object”, a part of the floor surface and the seat surface of the wheelchair are examples of a “second object”, and a part of the wall surface is an example of a “third object”.

The blower includes a vortex ring generator that generates the vortex ring Rv.

The vortex ring generator is a device that generates the vortex ring Rv and moves the vortex ring Rv in the air. Therefore, the vortex ring generator can be considered to be a device that moves the air in the audiovisual room 70. In the present embodiment, the vortex ring generator is classified as one of blowers. According to this aspect, since the vortex ring Rv generated by the vortex ring generator can move a relatively long distance without being dispersed, it is easy to aim at the user U and make the user U aware.

Also, the first motion includes at least one of a motion of the user U looking around, a motion of the user U moving in the audiovisual room 70, and a motion of the user U stopping in a specific region in the audiovisual room 70.

The user U who is made aware by the stimulus of the tactile sense may be consider to, besides performing a motion of looking around, move in a direction in which the stimulus of the tactile sense is received. The user U who is made aware by the stimulus of the tactile sense stops on the spot. According to this aspect, since the first motion is specifically illustrated, it is easier to determine whether the first motion satisfies the first condition.

The first image includes an image that changes from the second image to the third image.

The image that changes from the second image to the third image is not an image in which a certain image object is instantaneously switched to another image object, but is, for example, an image in which brightness, a color, a pattern, a shape, or the like of a certain image object changes. According to this aspect, since the image object changes at the opportunity of a change in the behavior of the user U appearing because the stimulus to the tactile sense of the user U is presented, the user U can be easily aware of the change in the image object even when a degree of the change in the image object is small. The image of the house in which the light is not turned on is an example of a “second image” and the image of the house in which the light leaks from the window is an example of a “third image”.

The presenting a stimulus includes presenting the stimulus at the intensity of the first degree and presenting the stimulus at the intensity of the second degree higher than the first degree when it is determined that the first motion does not satisfy the first condition.

There is an individual difference in a response to the stimulus of the tactile sense and, when an excessive stimulus is applied to the user U having a sensitive tactile sense, the user U feels discomfort. Conversely, it is conceivable that, even if a feeble stimulus is applied to the user U having a dull tactile sense, the user U is considered to be unaware of the stimulus. For that reason, it is desirable to increase the stimulus of the tactile sense stepwise. According to this aspect, it is possible to appropriately apply a stimulus considering an individual difference in a response to the stimulus of the tactile sense.

A program according to the first embodiment causes a computer to execute determining and displaying. The determining is processing for determining, based on output of the sensor 20 that detects a motion of the user U, whether the first motion of the user U after the stimulus to the tactile sense of the user U is presented satisfies the first condition. The displaying is processing for causing the display device 40-2 to display the first image on the wall surface 70-2 of the audiovisual room 70 when it is determined that the first motion satisfies the first condition.

With the program explained above, the first image is displayed when it is determined that the first motion of the user U after the stimulus is presented satisfies the first condition and the first image is displayed on the wall surface 70-2 at the opportunity of a change in the behavior of the user U. For this reason, since the user U is caused to feel as if the first image is displayed at the opportunity of awareness of the user U himself or herself and a change in the behavior of the user U, it is possible to give a deep sense of immersion to the user U viewing a video and increase the sense of presence.

The image display system 1 according to the first embodiment includes the sensor 20, the display devices 40-1 and 40-2, and the computer 10. The sensor 20 detects a motion of the user U. The display devices 40-1 and 40-2 display images in the audiovisual room 70. The computer 10 executes determining and displaying. The determining is processing for determining, based on output of the sensor 20, whether the first motion of the user U after a stimulus to the tactile sense of the user U is presented satisfies the first condition. The displaying is processing for causing the display device 40-2 to display the first image on the wall surface 70-2 of the audiovisual room 70 when it is determined that the first motion satisfies the first condition.

With the image display system 1 explained above, the first image is displayed when it is determined that the first motion of the user U after the stimulus is presented satisfies the first condition, and the first image is displayed on the wall surface 70-2 at the opportunity of a change in the behavior of the user U. For this reason, since the user U is caused to feel as if the first image is displayed at the opportunity of awareness of the user U himself or herself and a change in the behavior of the user U, it is possible to give a deep sense of immersion to the user U viewing a video and increase the sense of presence.

### 2. Second Embodiment

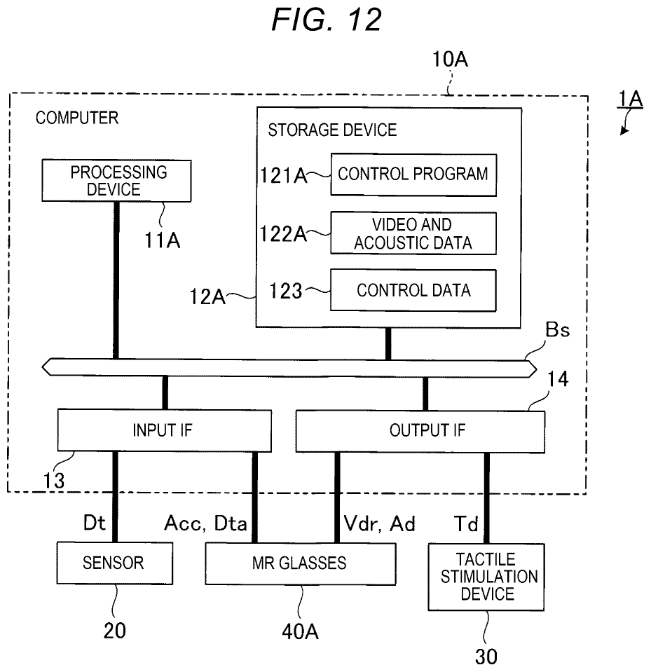

An image display system 1A according to a second embodiment of the present disclosure is explained below with reference to FIGS. 12 to 14. In the following explanation, for simplification of explanation, the same elements as the elements in the first embodiment are denoted by the same reference numerals and signs, and explanation of functions of the elements is sometimes omitted. In the following explanation, for simplification of explanation, differences of the second embodiment from the first embodiment are mainly explained.

### 2.1. Configuration in the Second Embodiment

FIG. 12 is a configuration diagram of the image display system 1A according to the second embodiment. The image display system 1A includes a computer 10A, the sensor 20, the tactile stimulation device 30, and mixed reality (MR) glasses 40A.

In the first embodiment, the video space is a real space. However, a video space in the second embodiment is a virtual space or a mixed reality space in which the real space and the virtual space are mixed. The user U can view and listen to a video displayed in the mixed reality space and sound by wearing the MR glasses 40A on the head.

The computer 10A is different from the computer 10 according to the first embodiment in that the computer 10A causes the MR glasses 40A to display an image and output sound. Configurations of the sensor 20 and the tactile stimulation device 30 in the second embodiment are the same as the configurations of the sensor 20 and the tactile stimulation device 30 in the first embodiment.

The computer 10A controls the units in the image display system 1A. The computer 10A includes a processing device 11A, a storage device 12A, the input IF 13, and the output IF 14. These devices are electrically coupled to one another via, for example, the bus Bs.

The processing device 11A controls an operation of the computer 10A. The processing device 11A includes one or more CPUs. However, the processing device 11A may include an FPGA, a DSP, an ASIC, or the like instead of the CPUs or in addition to the CPUs.

The storage device 12A includes a volatile memory such as a RAM and a nonvolatile memory such as a ROM. The storage device 12A stores the control program 121 for the processing device 11A to control the units, video and acoustic data 122A including video data and acoustic data, the control data 123 including control parameters of the tactile stimulation device 30, and the like. The volatile memory of the storage device 12A is used by the processing device 11A as a work area of the processing device 11A.

Since the configurations of the input IF 13, the output IF 14, the sensor 20, and the tactile stimulation device 30 are the same as the configurations of the input IF 13, the output IF 14, the sensor 20, and the tactile stimulation device 30 according to the first embodiment, detailed explanation of the configurations is omitted.

The MR glasses 40A are a wearable display device worn on the head of the user U. The MR glasses 40A cause display panels respectively provided in lenses corresponding to both the eyes of the user U to display virtual image objects. The lenses and the display panels of the MR glasses 40A are see-through. Therefore, the user U wearing the MR glasses 40A is capable of visually recognizing the real space as an external world image through the lenses and the display panels of the MR glasses 40A. The external world image may be a virtual image obtained by imaging the periphery of the user U. A scheme using a real external world image is referred to as optical see-through scheme. A scheme using a virtual external world image is referred to as video see-through scheme. In the following explanation, it is assumed that the MR glasses 40A adopt the optical see-through scheme. The MR glasses 40A are an example of a display device.

### 2.2. Functions of the Processing Device

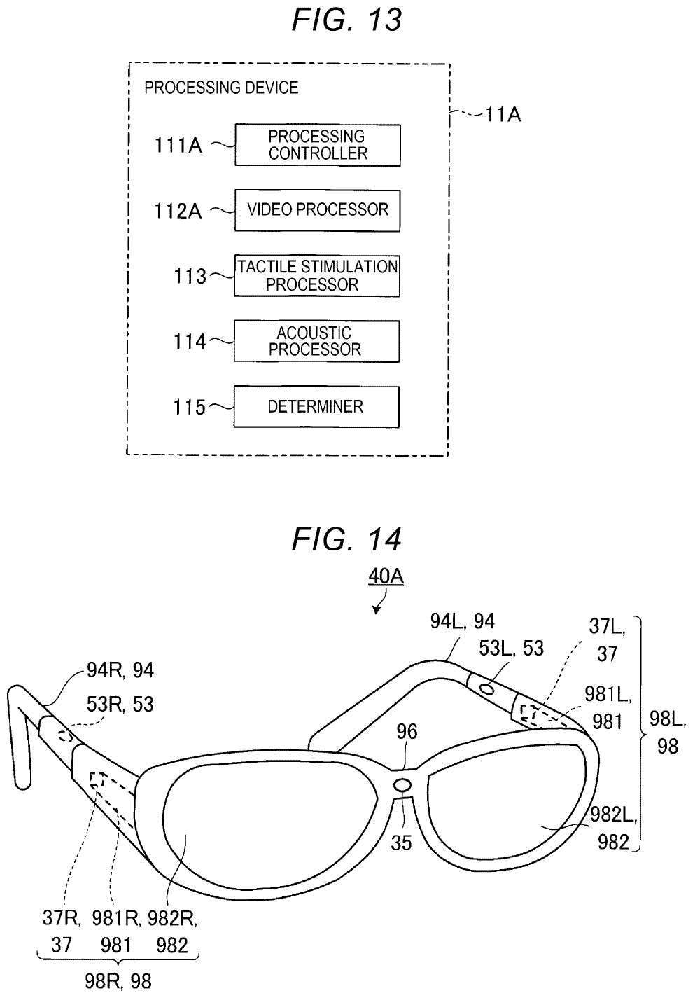

FIG. 13 is a functional block diagram illustrating an example of functions of the processing device 11A according to the second embodiment. FIG. 13 illustrates a functional configuration constructed by the processing device 11A of the computer 10A executing a control program 121A stored in the storage device 12A. As illustrated in FIG. 13, the processing device 11A has functions serving as a processing controller 111A, a video processor 112A, the tactile stimulation processor 113, the acoustic processor 114, and the determiner 115.

The processing controller 111A starts reading the video and acoustic data 122 from the storage device 12A according to a predetermined operation or the like and controls the units, that is, the video processor 112A, the tactile stimulation processor 113, the acoustic processor 114, and the determiner 115.

The video processor 112A generates, according to the control by the processing controller 111, the video signal Vd based on the video data in the video and acoustic data 122 read by the processing controller 111A. The video signal Vd generated in the video processor 112A is supplied to the MR glasses 40A via the output IF 14.

The tactile stimulation processor 113 generates, according to the control by the processing controller 111A, the control signal Cd based on the control data 123 read by the processing controller 111A. The control signal Cd generated in the tactile stimulation processor 113 is supplied to the tactile stimulation device 30 via the output IF 14.

The acoustic processor 114 outputs the acoustic data Ad in the video and acoustic data 122 read by the processing controller 111A. The acoustic data Ad output from the acoustic processor 114 is supplied to the MR glasses 40A via the output IF 14.

Since the determiner 115 has the same function as the function of the determiner 115 in the first embodiment, explanation of the function is omitted.

### 2.3. Configuration Example of the MR Glasses 40A

FIG. 14 is a perspective view illustrating the exterior of the MR glasses 40A illustrated in FIG. 13. The MR glasses 40A include a temple 94L, a temple 94R, a bridge 96, a projection optical system 98L, a projection optical system 98R, and a sound output device 53. In the following explanation, when elements of the same type are distinguished, suffixes such as “L” in the temple 94L and “R” in the temple 94R are used. When the elements of the same type are not distinguished, only a common number without a suffix like a temple 94 is used.

The temple 94 is a rod-shaped component supported by the auricle. The bridge 96 is disposed between the projection optical system 98L and the projection optical system 98R. The projection optical system 98 includes a display device 37, a light guide path 981, and a half mirror 982. An imaging device 35 is provided in the bridge 96. The imaging device 35 images the external world in the front of the user U.

The display device 37 is disposed in the temple 94. The display device 37 displays an image. The display device 37 includes, for example, various display panels such as a liquid crystal panel and an organic electro luminescence (EL) panel. When the display device 37 displays an image, light representing the image is emitted from the display device 37. The light emitted from the display device 37 is guided to the half mirror 982 by the light guide path 981. The half mirror 982 reflects the light guided by the light guide path 981. The light reflected by the half mirror 982 is projected onto the retina of the user U. The user U recognizes the image with the light. The half mirror 982 includes a surface facing the user U. When the display device 37 does not display an image, the user U can see the external world through the half mirror 982.

The sound output device 53 is disposed on a side surface of the temple 94. The sound output device 53 outputs sound. In the present embodiment, since the MR glasses 40A are controlled by the computer 10A, the MR glasses 40A do not particularly include an input device but may include an input device such as a touch sensor or may include a sound pickup device such as a microphone. When an acceleration sensor is incorporated in the MR glasses 40A, the acceleration sensor may be used as one type of the sensor 20 that detects movement of the head of the user U.

### 2.4. Disposition Example of the Image Display System 1A

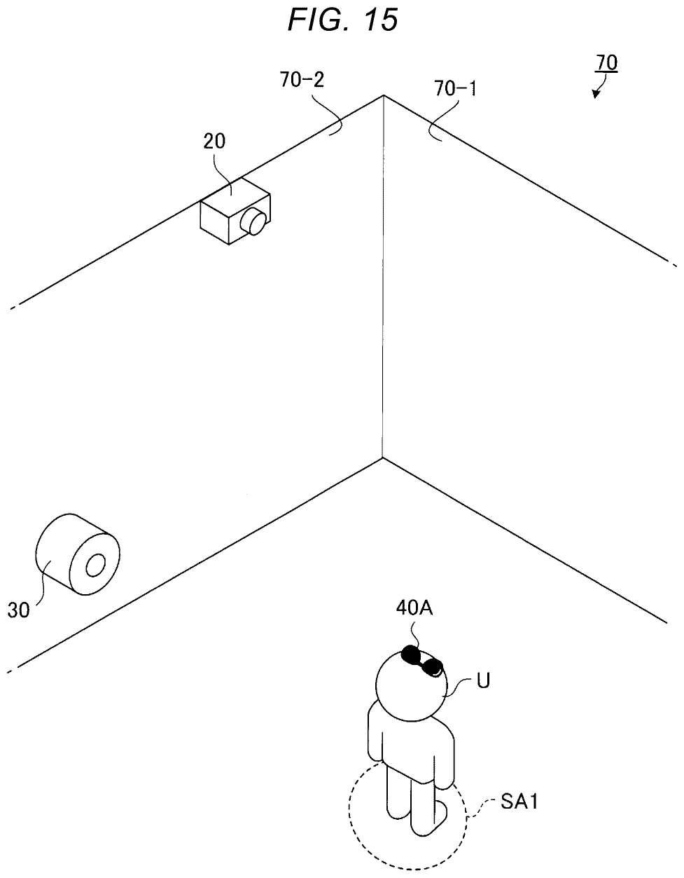

FIG. 15 is a diagram illustrating a disposition example of elements in the image display system 1A according to the second embodiment. The elements in the image display system 1A are provided in the audiovisual room 70. However, in FIG. 15, parts of the ceiling and the wall surface in the audiovisual room 70 are omitted in order to clearly explain the disposition example. The sensor 20 and the tactile stimulation device 30 are attached to, for example, the wall surface 70-2. The MR glasses 40A are worn on the head of the user U.

The sound output device 53 is provided in the MR glasses 40A. Sound can be output from the sound generation device 50 but may be output from an earphone worn by the user U. The speaker 52-1 may be provided in the audiovisual room 70. Sound may be output from the speaker 52-1 as in the first embodiment.

### 2.5. Operation of the Image Display System 1A

Posture information of the MR glasses 40A can be acquired by analyzing output signals Acc of various sensors including the acceleration sensor incorporated in the MR glasses 40A. Three-dimensional position information of the MR glasses 40A can be acquired by analyzing imaging data Dta obtained by the imaging device 35 of the MR glasses 40A. The three-dimensional position information of the MR glasses 40A can also be acquired by, for example, inertial navigation arithmetic operation with the entrance of the audiovisual room 70 set as a starting point and using the output signals Acc of the various sensors such as the acceleration sensor.

The processing device 11A renders the video signal Vd based on analyzed rotation information and three-dimensional position information of the MR glasses 40A. The processing device 11A supplies a video signal Vdr after the rendering to the MR glasses 40A. Accordingly, a video that changes according to a a rotation direction and three-dimensional position of the MR glasses 40A is displayed on the display device 37 of the MR glasses 40A. Therefore, the processing device 11 can cause the display device 37 to display the video as if the video is projected onto the wall surfaces 70-1 and 70-2.

### 2.6. Effects Achieved by the Second Embodiment

As explained above, the image display system 1A according to the second embodiment includes the sensor 20, the MR glasses 40A, and the computer 10A. The sensor 20 detects a motion of the user U. The MR glasses 40A display an image in the mixed reality space. The computer 10A executes determining and displaying. The determining is processing for determining, based on output of the sensor 20, whether the first motion of the user U after a stimulus to the tactile sense of the user U is presented satisfies the first condition. The displaying is the processing for causing the MR glasses 40A to display the first image in the first region of the mixed reality space when it is determined that the first motion satisfies the first condition.

According to this aspect, by using the MR glasses 40A, the user U is capable of viewing mixed reality in which the wall surfaces 70-1 and 70-2 in the real space and the background video and the image object in the virtual space are superimposed. Therefore, the user U is capable of having the same experience as the experience of the user U explained in the first embodiment. According to this aspect, the first image is displayed on the display device 37 at the opportunity when it is determined that the first motion of the user U satisfies the first condition. For this reason, since the first image is displayed because of awareness and an action of the user U himself of herself, it is possible to immerse the user U in viewing of a video.

### 3. Modifications

The present disclosure is not limited to the embodiments explained above, and various modifications can be adopted within the scope of the present disclosure. Specific aspects of the modifications are exemplified below. Two or more aspects optionally selected from the following exemplifications can be combined as appropriate within a range in which the aspects do not contradict one another. In the modifications illustrated below, the reference numerals and signs used in the above explanation are used for elements having action and functions equivalent to those in the embodiments explained above, and detailed explanation of the elements is omitted as appropriate.

### 3.1. Modification 1

In the embodiments explained above, the timing when the stimulus of the tactile sense is applied is the timing when the user is present in the first specific region but may follow a predetermined time table or may be synchronized with video data. The timing when the stimulus of the tactile sense is applied may be every timing when a fixed time elapses or may be random timing.

### 3.2. Modification 2

In the embodiments explained above, the appearance of the image object superimposed on the background video is changed at the opportunity of a change in the behavior of the user who has been aware of the stimulus of the tactile sense. However, an image object to be displayed may be instantaneously switched to another image object. The background video may be dynamically switched to another background video.

### 3.3. Modification 3

In the embodiments explained above, the case in which only one user is present in the audiovisual room 70 is assumed. However, when two or more users are present, for example, the first image may be displayed at the opportunity when the number of users whose first motion has satisfied the first condition has exceeded the majority of all the present users.

### 3.4. Modification 4

In the embodiments explained above, the aspect of the video is changed at the opportunity of a change in the behavior of the user that appears because the tactile sense of the user is stimulated. However, the stimulus applied to the user may include a stimulus to a sense other than the tactile sense, for example, the visual sense. Specifically, some image object may be displayed in the video to make the user aware or a video different from that in other regions may be displayed in a part of regions.

The auditory sense may be used as the stimulus applied to the user. For example, when the user is viewing a video simultaneously with listening to BGM, sound different from the BGM may be generated at certain timing and a mode of the video displayed to that point may be changed at the opportunity of a behavior change indicating that the user has been aware of the sound. The olfactory sense may be used as the stimulus applied to the user. For example, liquid having a scent may be sprayed and a mode of a video may be changed at the opportunity of a behavior change indicating that the user has been aware of the scent.

### 3.5. Modification 5

In the first embodiment, the device usable as the tactile stimulation device 30 is exemplified. However, the tactile stimulation device 30 is not limited to the device exemplified in the first embodiment. For example, the tactile stimulation device 30 may be a dedicated device that reproduces a situation in which a dead branch is broken when the user steps on the dead branch. The dedicated device includes, for example, a pressure sensor, an actuator, and a rugged aluminum plate and is disposed below the floor surface. When the user U steps on the pressure sensor, the pressure sensor outputs a signal corresponding to the pressure of the stepping. When the signal output from the pressure sensor exceeds a threshold, the actuator generates stress in the aluminum plate and applies distortion to the aluminum plate. When the user U steps on the dedicated device explained above, the tactile sense of the user U is stimulated and awareness can occur to the user U.

### 3.6. Modification 6

In the second embodiment, the aspect in which the user U views, using the MR glasses 40A, the mixed reality in which the wall surfaces 70-1 and 70-2 in the real space and the background video and the image object in the virtual space are superimposed is explained. However, without being limited to the aspect of the second embodiment, the user U may view, using the MR glasses 40A, a video in which the background video and the image object are projected on a screen in the virtual space.

### 3.7. Modification 7

The MR glasses 40A according to the second embodiment are the device that is the see-through type and with which the mixed reality can be experienced. However, virtual reality (VR) goggles with which virtual reality can be experienced may be used instead of the MR glasses 40A. When the VR goggles are used, the user U wearing the VR goggles on the head basically stays at a predetermined viewing position and views a video. However, even in the aspect explained above, since the first image is displayed in the virtual space because of awareness and an action of the user U himself or herself, it is possible to immerse the user U in the viewing of the video.

### 4. Appendices

A summary of the present disclosure is appended below.

### 4.1. Appendix 1

An image display method according to an Appendix 1 includes: presenting a stimulus to a tactile sense of a user; determining, based on output of at least one sensor that detects a motion of the user, whether a first motion of the user after the stimulus is presented satisfies a first condition; and displaying a first image in a first region of a video space with at least one display when it is determined that the first motion satisfies the first condition.

With the image display method according to the Appendix 1, the first image is displayed when it is determined that the first motion of the user after the stimulus is presented satisfies the first condition. Since the first image is displayed at the opportunity of change in the behavior of the user, it is difficult to cause the user to feel the artifice of a video creator and it is easy for the user to feel as if a video changed at the opportunity of a change in the awareness and the behavior of the user himself or herself. Therefore, it is possible to give a deep sense of immersion to the user viewing the video.

### 4.2. Appendix 2

An image display method according to an Appendix 2 is the image display method according to the Appendix 1, wherein the first condition is at least one of the user directing a face of the user in a direction of the first region and the user visually recognizing an image displayed in the first region.

With the image display method according to the Appendix 2, the user can easily find the displayed first image.

### 4.3. Appendix 3

An image display method according to an Appendix 3 is the image display method according to the Appendix 1 or 2, wherein the presenting the stimulus includes at least one of: moving air in the video space with a blower; bringing a first object in the video space into contact with the user with the blower; vibrating a second object in contact with the user with a vibrator; and bringing a third object in the video space into contact with the user with a driver.

With the image display method according to the Appendix 3, as in the Appendix 2, the user can easily find the displayed first image.

### 4.4. Appendix 4

An image display method according to an Appendix 4 is the image display method according to the Appendix 3, wherein the blower includes a vortex ring generator that generates a vortex ring.

With the image display method according to the Appendix 4, it is easy to aim at the user and make the user aware.

### 4.5. Appendix 5

An image display method according to an Appendix 5 is the image display method according to any one of the Appendices 1 to 4, wherein the first motion includes at least one of a motion of the user looking around, a motion of the user moving in the video space, and a motion of the user stopping in a specific region in the video space.

With the image display method according to the Appendix 5, since the first motion is specifically indicated, it is easier to determine whether the first motion satisfies the first condition.

### 4.6. Appendix 6

An image display method according to an Appendix 6 is the image display method according to any one of the Appendices 1 to 5, wherein the first image includes an image that changes from a second image to a third image.

With the image display method according to the Appendix 6, since the image object changes at the opportunity of a change in the behavior of the user U that appears because the tactile sense of the user is stimulated, the user can be easily aware of the change in the image object even when a degree of the change in the image object is small.

### 4.7. Appendix 7

An image display method according to an Appendix 7 is the image display method according to any one of the Appendices 1 to 6, wherein the presenting the stimulus includes presenting the stimulus at a first degree as a degree of the stimulus, and presenting the stimulus at a second degree higher than the first degree when it is determined that the first motion does not satisfy the first condition.

With the image display method according to the Appendix 7, it is possible to appropriately apply a stimulus considering an individual difference of a response to a stimulus of the tactile sense.

### 4.8. Appendix 8

A non-transitory computer-readable storage medium storing a program according to an Appendix 8, the program causing a computer to execute: determining, based on output of at least one sensor that detects a motion of a user, whether a first motion of the user after a stimulus to a tactile sense of the user is presented satisfies a first condition; and causing at least one display to display a first image in a first region of a video space when it is determined that the first motion satisfies the first condition.

With the non-transitory computer-readable storage medium storing the program according to the Appendix 8, as in the Appendix 1, it is difficult to cause the user to feel the artifice of a video creator and it is easy for the user to feel as if a video changed at the opportunity of a change in the awareness and the behavior of the user himself or herself. Therefore, it is possible to give a deep sense of immersion to the user viewing the video.

### 4.9. Appendix 9

An image display system according to an Appendix 9 includes: at least one sensor configured to detect a motion of a user; at least one display configured to display an image in a video space; and a processor configured to execute: determining, based on output of the at least one sensor, whether a first motion of the user after a stimulus to a tactile sense of the user is presented satisfies a first condition; and causing the at least one display to display a first image in a first region of the video space when it is determined that the first motion satisfies the first condition.

With the image display system according to the Appendix 9, as in the Appendix 1, it is difficult to cause the user to feel the artifice of a video creator and it is easy for the user to feel as if a video changed at the opportunity of a change in the awareness and the behavior of the user himself or herself. Therefore, it is possible to give a deep sense of immersion to the user viewing the video.

What is claimed is:

1. An image display method comprising:
presenting a stimulus to a tactile sense of a user;
determining, based on output of at least one sensor that detects a motion of the user, whether a first motion of the user after the stimulus is presented satisfies a first condition; and
displaying a first image in a first region of a video space with at least one display when it is determined that the first motion satisfies the first condition.

2. The image display method according to claim 1, wherein the first condition is at least one of the user directing a face of the user in a direction of the first region and the user visually recognizing an image displayed in the first region.

3. The image display method according to claim 1, wherein the presenting the stimulus includes at least one of:
moving air in the video space with a blower;
bringing a first object in the video space into contact with the user with the blower;
vibrating a second object in contact with the user with a vibrator; and
bringing a third object in the video space into contact with the user with a driver.

4. The image display method according to claim 3, wherein the blower includes a vortex ring generator that generates a vortex ring.

5. The image display method according to claim 1, wherein the first motion includes at least one of a motion of the user looking around, a motion of the user moving in the video space, and a motion of the user stopping in a specific region in the video space.

6. The image display method according to claim 1, wherein the first image includes an image that changes from a second image to a third image.

7. The image display method according to claim 1, wherein the presenting the stimulus includes presenting the stimulus at a first degree as a degree of the stimulus, and presenting the stimulus at a second degree higher than the first degree when it is determined that the first motion does not satisfy the first condition.

8. A non-transitory computer-readable storage medium storing a program, the program causing a computer to execute:
determining, based on output of at least one sensor that detects a motion of a user, whether a first motion of the user after a stimulus to a tactile sense of the user is presented satisfies a first condition; and
causing at least one display to display a first image in a first region of a video space when it is determined that the first motion satisfies the first condition.

9. An image display system comprising:
at least one sensor configured to detect a motion of a user;
at least one display configured to display an image in a video space; and
a processor configured to execute:
determining, based on output of the at least one sensor, whether a first motion of the user after a stimulus to a tactile sense of the user is presented satisfies a first condition; and
causing the at least one display to display a first image in a first region of the video space when it is determined that the first motion satisfies the first condition.
